(19) United States
(12) Patent Application Publication
(10) Pub. No.: US 2005/0196525 A1
(43) Pub. Date: Sep. 8, 2005

(54) Cutting and delivering cut OLED donor sheets

(75) Inventor: Bradley A. Phillips, Honeoye Falls, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/792,334

(22) Filed: Mar. 3, 2004

(51) Int. Cl. B05D 5/12

(52) U.S. Cl. 427/66

(57) ABSTRACT

A method of delivering donor sheets to be subsequently processed in the process of making an organic light-emitting device including providing a roll of a flexible substrate which can either include organic layers or subsequently be coated with organic layers and unrolling a predetermined length of donor and cutting the donor sheet to a size suitable for subsequent use in depositing organic layers. The method also includes transferring the cut donor sheet into a sheet receiver onto a frame and securing the donor sheet to the sheet receiver and delivering the sheet receiver and the secured donor sheet to a position to be further processed.

### FIELD OF THE INVENTION

The present invention relates to the manufacture of framed donor sheets used for use in the manufacture of organic light-emitting diode (OLED) display devices.

### BACKGROUND OF THE INVENTION

OLED displays are one of the most recent flat panel display technologies and are predicted to overtake LCD display technology within the next decade. OLED displays offer brighter displays, significantly wider viewing angles, lower power requirements, and longer lifetimes than their LCD counterparts. OLED technology offers more display flexibility and alternatives to backlit LCD displays. For example, OLED displays can be made of thin, flexible materials that conform to any desired shape for specific applications. However, OLED displays and their components, known as OLED structures, which constitute subpixels of the display, are more difficult and costly to manufacture than LCD displays. It is a continuing focus of the industry to increase the throughput in an effort to lower the cost of OLED manufacturing.

Conventional OLED display devices are built on glass substrates in a manner such that a two-dimensional OLED array for image manifestation is formed. The basic OLED cell structure includes a stack of thin organic layers sandwiched between an array of anodes and a common metallic cathode. The organic layers comprise a hole transport layer (HTL), an emissive layer (EL), and an electron transport layer (ETL). When an appropriate voltage is applied to the cell, the injected holes and electrons recombine in the EL near the EL-HTL interface to produce light (electroluminescence).

The EL within a color OLED display device most commonly includes three different types of fluorescent molecules that are repeated through the EL. Red, green, and blue regions, or subpixels, are formed throughout the EL during the manufacturing process to provide a two-dimensional array of pixels. Each of the red, green, and blue subpixel sets undergoes a separate patterned deposition, for example, by evaporating a linear source through a shadow mask. Shadow masking is a well known technology, yet it is limited in the precision of its deposition pattern and in the pattern's fill factor or aperture ratio; thus, incorporating shadow masking into a manufacturing scheme limits the achievable sharpness and resolution of the resultant display. Laser thermal transfer promises a more precise deposition pattern and higher aperture ratio; however, it has proved challenging to adapt laser thermal transfer to a throughput manufacturing line, which is necessary to warrant its use in the manufacture of cost-effective OLED display devices.

During laser thermal transfer, a donor sheet having the desired organic material is placed into close proximity to the OLED substrate within a vacuum chamber. A laser impinges through a clear support that provides physical integrity to the donor sheet and is absorbed within a light-absorbing layer contained atop the support. The conversion of the laser's energy to heat sublimates the organic material that forms the top layer of the donor sheet and thereby transfers the organic material in a desired subpixel pattern to the OLED substrate. The donor sheets are ideally fed automatically into the process such that the stoppages between depositions can be minimized.

U.S. Pat. No. 6,485,884 provides a method for patterning oriented materials to make OLED display devices, and also provides donor sheets for use with the method, as well as methods for making the donor sheets. However, U.S. Pat. No. 6,485,884 fails to provide a continuous way to manufacture the donor sheets. Donor sheets must be cut from a sheet of fragile web prior to being coating with the organic material layer that is subsequently deposited on the OLED display via laser thermal transfer. To provide the ease of robotic handling necessary for a high throughput process, it is also desirable to provide a continuous way of mounting the donor sheets to frames.

### SUMMARY OF THE INVENTION

It is an object of the present invention to provide an effective way of delivering cut donor sheets into a frame for use in OLED manufacturing.

It is therefore another object of the invention to provide a high-throughput method for the cutting and framing of donor sheets from a roll of web for use in the manufacture of OLED display devices.

The present invention is a high-throughput system for cutting and framing donor sheets from a roll of web for use in laser thermal transfer during the manufacture of OLED display devices.

This object is achieved by a method of delivering donor sheets to be subsequently processed in the process of making an organic light-emitting device, comprising:
a) providing a roll of a flexible substrate which can either include organic layers or subsequently be coated with organic layers;
b) unrolling a predetermined length of donor and cutting the donor sheet to a size suitable for subsequent use in depositing organic layers;
c) transferring the cut donor sheet into a sheet receiver onto a frame and securing the donor sheet to the sheet receiver; and
d) delivering the sheet receiver and the secured donor sheet to a position to be further processed.

### ADVANTAGES

The present invention provides an improved way of delivering cut donor sheets into frames for use in subsequent OLED manufacturing. A particular feature of the present invention is the use of cassettes for receiving frames each with a corresponding cut sheet. The cassette is then used in the OLED manufacturing process.

### BRIEF DESCRIPTION OF THE DRAWINGS

FIGS. 1A and 1B illustrate perspective and side views, respectively, of a donor sheet conversion apparatus in accordance with the present invention;

FIG. 2 illustrates a manual frame-mounting scheme in accordance with the present invention;

FIG. 3 illustrates a support platform that is included in the manual frame-mounting scheme;

FIG. 4 illustrates an automatic frame-mounting apparatus in accordance with the present invention; and

FIG. 5 illustrates another embodiment of the automatic frame-mounting apparatus of the present invention.

### DETAILED DESCRIPTION OF THE INVENTION

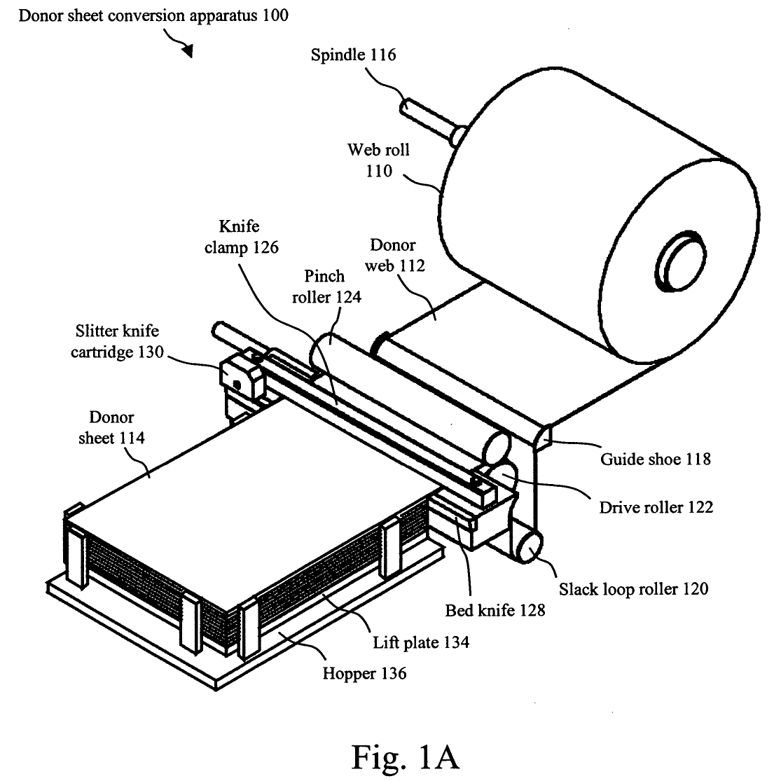

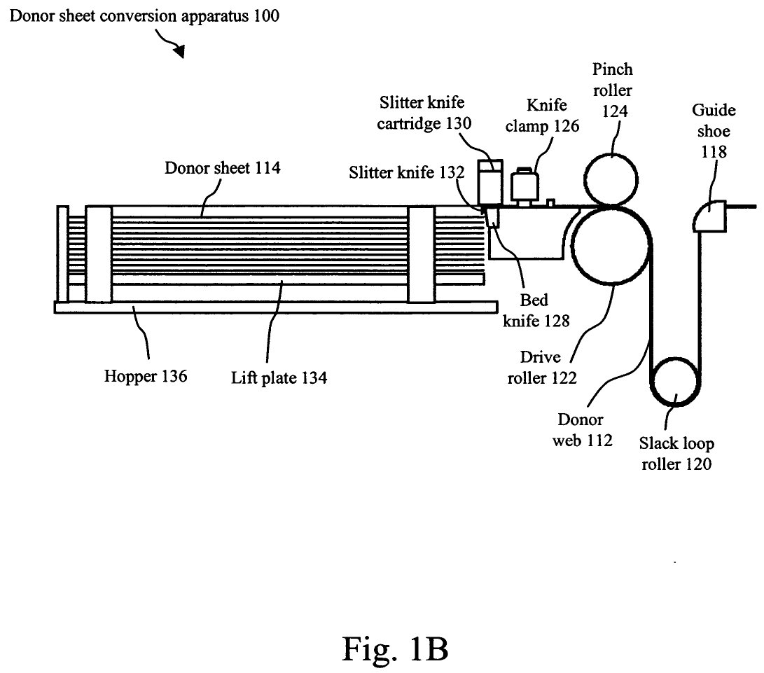

FIGS. 1A and 1B illustrate views of a donor sheet conversion apparatus 100 for converting a web roll 110 supported axially upon a motorized unwind spindle 116 into a plurality of donor sheets 114. After a predetermined length of web is unrolled, donor sheets are cut from the web. Donor sheets 114 form the support for a subsequently deposited organic material layer that is later selectively transferred in an appropriate pattern via laser thermal transfer to provide the emissive material throughout a color group of subpixels within an OLED display device. It is understood that donor web 112 can be precoated with an organic material layer prior to processing on sheet donor conversion apparatus 100. Web roll 110 is supplied in the form of a large roll of a donor web 112 that is, in one example, 3 mills thick, 22 inches wide, and hundreds of yards long. Web roll 110, as well as donor sheet 114, in one example includes a flexible substrate that is fabricated from high-temperature polymeric material such as a thermoplastic with an aromatic backbone and is precoated with a light-absorbing layer such as metallic chromium and an optional antireflecting layer such as silicon.

Donor sheet conversion apparatus 100 further includes a drive roller 122 that pays out donor web 112 over a guide shoe 118, a slack loop roller 120 that maintains an appropriate level of tension in donor web 112, and a pinch roller 124 that helps to drive the forward motion of donor web 112. Guide shoe 118 is a mechanical means of guiding donor web 112 such that donor web 112 does not run off its track while advancing. Donor sheet conversion apparatus 100 further includes a bed knife 128, against which translates a slitter knife 132 (shown in FIG. 1B), which can rotate and is supported by a slitter knife cartridge 130 that is in turn translationally supported along a rail (not shown). A clamping mechanism 126 is provided for securing donor web 112 during the act of cutting.

Donor sheet conversion apparatus 100 can further include a hopper 136 that collects donor sheets 114 upon their singulation. Hopper 136 includes a lift plate 134 that is mounted on an elevator mechanism (not shown) for stacking singulated donor sheets 114.

Donor sheet conversion apparatus 100 is assumed to further include an appropriate level of machine control electronics and software.

In operation, donor sheet conversion apparatus 100 converts web roll 110 to a stack of singulated donor sheets 114. Motorized spindle 116 mounts web roll 110 and pays out donor web 112. Slack loop roller 120 is weighted and vertically positioned so as to provide an appropriate amount of tension in donor web 112, and so as to control the rotation of spindle 116 and the payout rate of donor web 112. Alternately, a vacuum box looper or vacuum drum can be substituted for slack loop roller 120 and would limit surface contact with precoated donor web 112. Drive roller 122, along with pinch roller 124, serve as a drive assembly that advances donor web 112 a predetermined distance and subsequently halts the translation of donor web 112 to await cutting. The predetermined distance for advancing donor web 112 before halting its translation for singulation into donor sheets 114 can be accomplished, for example, using rotary encoder counts of the rotation of drive roller 122 or direct sensor detection of the lead edge of donor web 112. Once the translation of donor web 112 is halted, clamping mechanism 126 secures donor web 112 while slitter knife cartridge 130 translates along a rail (not shown) that forms a line of contact between slitter knife 132 and bed knife 128. As rotating slitter knife 132 translates across bed knife 128, a cut is made on donor web 112 that forms donor sheet 114. Slitter knife 132 can be translated along bed knife 128 in a number of ways, including manually or with the use of a pneumatic cylinder or a motor-driven lead screw. Other cutting assemblies can be substituted for bed knife 128 and slitter knife 132, such as a point contact shear cutter (chopper) or a laser cutting assembly. Clamping mechanism 126 can be operated manually or by an actuator. As the cut is made, donor sheet 114 is formed. Donor sheet 114 is stacked atop previously formed donor sheets 114 in hopper 136 while lift plate 134 lowers an incremental vertical distance to accommodate the next donor sheet 114.

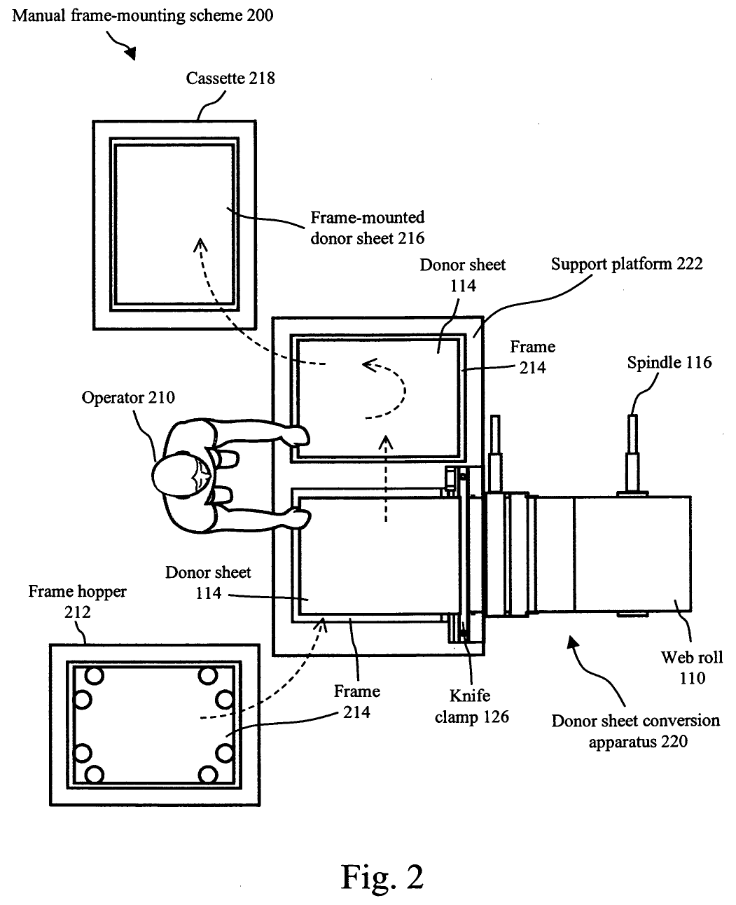

The next step in preparing uncoated donor sheets 114 for the subsequently deposited organic material layer is to mount donor sheets 114 to frames. Frames can be mounted to donor sheets 114 manually in a number of ways, such as by collecting a stack of donor sheets 114 in hopper 136, as previously described, and subsequently providing loaded hopper 136 to an operator at a work table, at which time the operator manually mounts each donor sheet 114 to a frame and forms a stack of mounted donor sheets 114 in a cassette 218. FIG. 2 illustrates an alternate way to manually mount donor sheets 114 to frames.

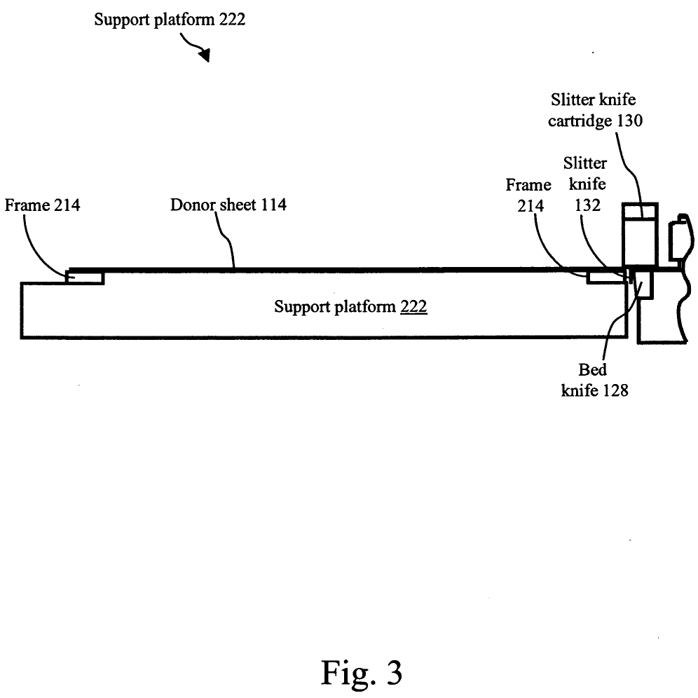

FIG. 2 illustrates a manual frame-mounting scheme 200 and includes an operator 210, a frame hopper 212 that houses a plurality of rigid frames 214, a frame-mounted donor sheet 216 that is formed by operator 210, the cassette 218, and a donor sheet conversion apparatus 220. Cassette 218 is a transport vessel capable of being pumped down to achieve a desired vacuum condition and is docked to a subsequent coating apparatus or process station such as a deposition chamber. Donor sheet conversion apparatus 220 is identical to donor sheet conversion apparatus 100, except that hopper 136 and lift plate 134 are replaced by a support platform 222. Support platform 222 includes an indentation for housing a frame 214 and a plateau for positioning and aligning donor sheet 114 atop frame 214, as illustrated in FIG. 3. Frame hopper 212 can include a lift plate connected to an elevator mechanism so as to maintain the position of frames 214 near the top of frame hopper 212 for ease of manual withdrawal.

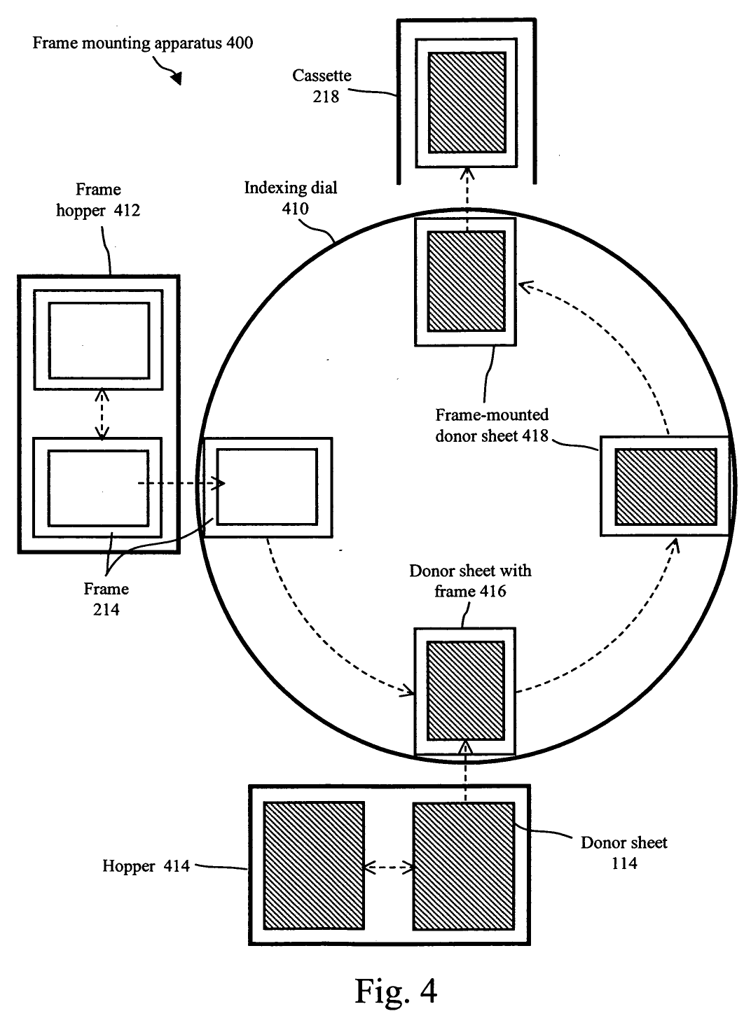

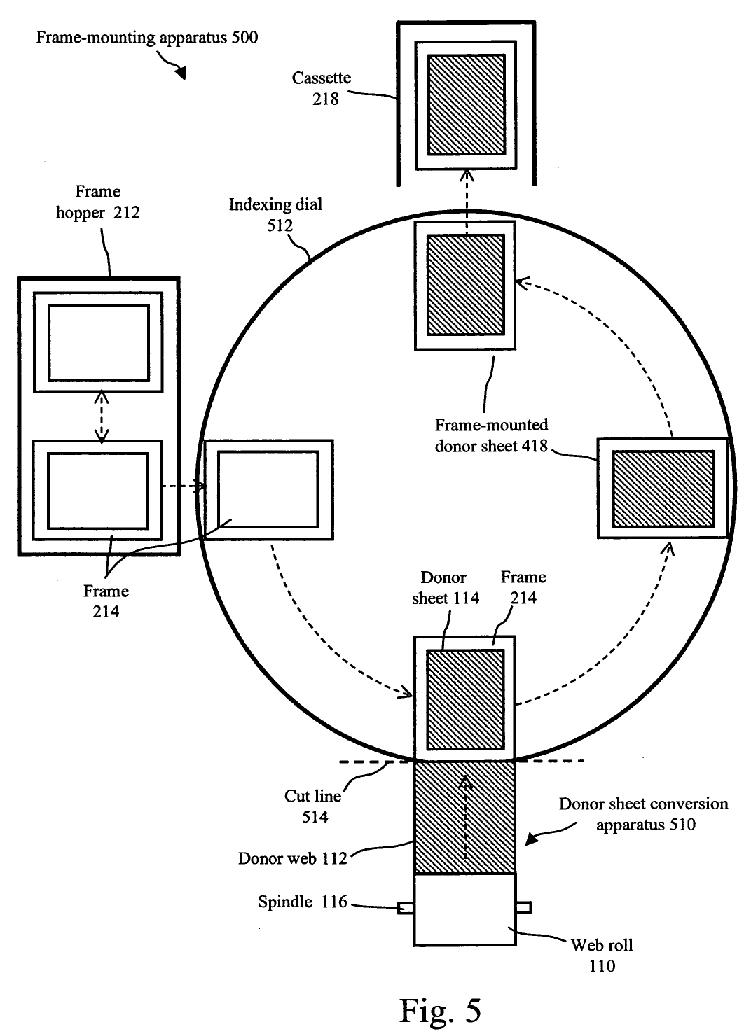

In operation, and in reference to FIGS. 2 and 3, the operator 210 is positioned in close proximity to the end of donor sheet conversion apparatus 220. Operator 210 removes frame 214 from frame hopper 212 and fits frame 214 into an indented form on support platform 222. The lead edge of donor web 112 is automatically cut, thereby forming donor sheet 114 that falls atop frame 214. Operator 210 aligns donor sheet 114 to frame 214, if necessary, and mounts the nearer edge of donor sheet 114 to frame 214 by any number of methods, such as by using glue, double-sided tape, clamps, clips, heat, etc. Operator 210 then rotates donor sheet 114, along with frame 214, 180° and mounts the opposite side of donor sheet 114 to frame 214, thereby forming frame-mounted donor sheet 216, which the operator places into cassette 218. In an alternate embodiment, a second operator can be included in manual frame-mounting scheme 200 to achieve higher throughput. The second operator receives donor sheets 114 having one side mounted to frames 214 from operator 210. The second operator then mounts the opposite side of donor sheets 114 to frames 214 and places frame-mounted donor sheets 216 into cassette 218. A variety of mechanical approaches also exist for mounting donor sheets 114 to frames 214, as are described in reference to FIGS. 4 and 5.

FIG. 4 illustrates a frame-mounting apparatus 400 that includes an indexing dial 410. The indexing dial 410 sequentially receives a cut sheet one at a time to a frame at the sheet receiving position on the indexing dial, and transferring each such cut donor sheet to a corresponding frame and securing each such cut donor sheet to its corresponding frame. The indexing dial 410 incrementally rotates and aligns donor sheets 114 with frames 214 to form a plurality of donor sheets with frames 416 and to subsequently form a plurality of frame-mounted donor sheets 418. Frame-mounting apparatus 400 further includes a frame hopper 412 that houses a plurality of frames 214, a hopper 414 that houses a plurality of donor sheets 114, and cassette 218. Hopper 414 can be similar or identical to hopper 136 or, alternately, can be a dual-stack hopper that houses two adjacent stacks of donor sheets 114 and enables a depleted stack to be replaced by the mechanical translation of the full stack into the depleted stack space. The empty half of hopper 414 can then be filled while donor sheets 114 are being fed into frame-mounting apparatus 400 from the non-depleted frame hopper 412 can be similar or identical to frame hopper 212 or, alternately, can be a dual-stack hopper that houses two adjacent stacks of frames 214 and enables a depleted stack to be replaced by the mechanical translation of the full stack into the depleted stack space. In such a way, increased throughput is realized by limiting the necessity for work stoppages. Frame-mounting apparatus 400 further includes an appropriate set of robotics (not shown) for transferring frames 214 into indexing dial 410, an appropriate set of robotics (not shown) for transferring donor sheets 114 into indexing dial 410, an appropriate set of robotics (not shown) for mounting donor sheets 114 to frames 214, and an appropriate set of robotics (not shown) for transferring frame-mounted donor sheets 418 into cassette 218.

In operation, a set of robotics automatically transfers frame 214 from dual-stack frame hopper 412 into indexing dial 410. Indexing dial 410 incrementally rotates, e.g., 90°, bringing frame 214 to a position at which a set of robotics automatically transfers donor sheet 114 from hopper 414 into indexing dial 410, and appropriately aligns donor sheet 114 atop frame 214 to form donor sheet with frame 416. Indexing dial 410 incrementally rotates again, bringing donor sheet with frame 416 to a position at which a set of robotics automatically mounts donor sheet 114 to frame 214, e.g. by clamping, to form frame-mounted donor sheet 418. Indexing dial 410 incrementally rotates again, transferring frame-mounted donor sheet 418 to a position at which a set of robotics automatically transfers frame-mounted donor sheet 418 from indexing dial 410 into cassette 218. During each incremental stop of indexing dial 410, a new frame 214 is robotically transferred from frame hopper 412 into indexing dial 410, a new donor sheet 114 is robotically transferred from hopper 414 into indexing dial 410 and onto frame 214, a new frame-mounted donor sheet 418 is formed from donor sheet with frame 416, and a new frame-mounted donor sheet 418 is robotically unloaded from indexing dial 410 into cassette 218. Once cassette 218 is filled with frame-mounted donor sheets 418, cassette 218 is undocked from frame-mounting apparatus 400, eventually to be pumped down to an appropriate level of vacuum and docked with a process chamber for organic material layer deposition. In an alternate embodiment, donor sheets 114 can be fed directly into indexing dial 410 from donor sheet conversion apparatus 100, as described with reference to FIG. 5.

FIG. 5 illustrates a frame-mounting apparatus 500 that includes a donor sheet conversion apparatus 510 that is identical to donor sheet conversion apparatus 100 in all respects, except that hopper 136 and lift plate 134 are replaced with a simple support platform (not shown) affixed to an indexing dial 512. Indexing dial 512 is identical in all respects to indexing dial 410 except that the appropriate robotics for transferring donor sheets 114 from hopper 414 into frame-mounting apparatus 500 are replaced by functionality enabling an appropriate coupling between donor sheet conversion apparatus 510 and indexing dial 512. Frame-mounting apparatus 500 further includes frame hopper 212, frames 214, frame-mounted donor sheets 418, and cassette 218. A cut line 514 is shown for illustrative purposes.

The operation of frame-mounting apparatus 500 is similar in all respects to the operation of frame-mounting apparatus 400 except that the lead edge of donor web 112 pays out directly into indexing dial 512, a cut is made along cut line 514, and donor sheet 114 is laid atop frame 214. Frame-mounted donor sheets 418 are formed from donor sheets 114 and frames 214 and are transferred into cassette 218 in a manner identical to that described in reference to frame-mounting apparatus 400.

The invention has been described in detail with particular reference to certain preferred embodiments thereof, but it will be understood that variations and modifications can be effected within the spirit and scope of the invention.

### PARTS LIST

100 donor sheet conversion apparatus
110 web roll
112 donor web
114 donor sheet
116 motorized unwind spindle
118 guide shoe
120 slack loop roller
122 drive roller
124 pinch roller
126 clamping mechanism
128 bed knife
130 slitter knife cartridge
132 slitter knife
134 lift plate
136 hopper
200 manual frame-mounting scheme
210 operator
212 frame hopper
214 rigid frames
216 frame-mounted donor sheet
218 cassette
220 donor sheet conversion apparatus
222 support platform
400 frame-mounting apparatus
410 indexing dial
412 frame hopper
414 hopper
416 frames
418 frame-mounted donor sheets
500 frame-mounting apparatus
510 donor sheet conversion apparatus
512 indexing dial
514 cut line

1. A method of delivering donor sheets to be subsequently processed in the process of making an organic light-emitting device, comprising:
a) providing a roll of a flexible substrate which can either include organic layers or subsequently be coated with organic layers;
b) unrolling a predetermined length of donor and cutting the donor sheet to a size suitable for subsequent use in depositing organic layers;
c) transferring the cut donor sheet into a sheet receiver onto a frame and securing the donor sheet to the sheet receiver; and
d) delivering the sheet receiver and the secured donor sheet to a position to be further processed.

2. The method according to claim 1 wherein the cut donor sheet receiver is a frame.

3. The method according to claim 1 wherein the sheet receiver includes a clamping mechanism for positioning the cut donor sheet and releasing the clamping mechanism and transferring the cut donor sheet for further processing.

4. A method of delivering donor sheets to be subsequently coated with organic layers which can be thermally transferred in the process of making an organic light-emitting device, comprising:
a) providing a roll of a flexible substrate on which organic layers can subsequently be coated;
b) unrolling a predetermined length of donor and cutting the donor sheet to a size suitable for subsequent use in a coating apparatus;
c) transferring the cut donor sheet directly onto a frame and securing the donor sheet to the frame; and
d) delivering the frame into a cassette and transferring the cassette with the frame having the secured donor sheet to be coated.

5. A method of delivering donor sheets to be subsequently coated with organic layers which can be thermally transferred in the process of making an organic light-emitting device, comprising:
a) providing a roll of a flexible substrate on which organic layers can subsequently be coated;
b) unrolling a predetermined length of donor and cutting the donor sheet to a size suitable for subsequent use in a coating apparatus;
c) transferring the cut donor sheet into a hopper;
d) repeating steps b) and c) until a predetermined number of cut sheets are disposed in the hopper;
e) sequentially delivering a cut sheet one at a time to a corresponding frame and transferring each cut donor sheet in its frame into a cassette; and
f) transferring the cassette with a plurality of frames each having a cut donor sheet to a coating apparatus.

6. A method of delivering donor sheets to be subsequently coated with organic layers which can be thermally transferred in the process of making an organic light-emitting device, comprising:
a) providing a roll of a flexible substrate on which organic layers can subsequently be coated;
b) unrolling a predetermined length of donor and cutting the donor sheet to a size suitable for subsequent use in a coating apparatus;
c) transferring the cut donor sheet into a hopper;
d) repeating steps b) and c) until a predetermined number of cut sheets are disposed in the hopper;
e) transporting sheet receiving frames to an indexing dial which sequentially positions each frame in a sheet receiving position;
f) sequentially delivering a cut sheet one at a time to a frame disposed at the sheet receiving position on the indexing dial and transferring each such cut donor sheet to a corresponding frame and securing each such cut donor sheet to its corresponding frame;
g) moving the indexing dial to position a frame with a cut donor sheet into a cassette receiving position;
h) delivering a frame with its cut donor sheet into a cassette at the cassette receiving position; and
i) transferring the cassette with a plurality of frames each having the secured donor sheet to a coating apparatus.

7. A method of delivering donor sheets to be subsequently coated with organic layers which can be thermally transferred in the process of making an organic light-emitting device, comprising:
a) providing a roll of a flexible substrate on which organic layers can subsequently be coated;
b) transporting sheet receiving frames to an indexing dial which sequentially positions each frame to a sheet receiving position;
c) unrolling and delivering a predetermined length of donor to a frame in the sheet receiving position and cutting the donor sheet to a size suitable for subsequent use in a coating apparatus and securing the donor sheet to the frame;
d) the indexing dial positioning the frame with a cut donor sheet to a cassette receiving position and transferring the frame with a cut donor sheet to a corresponding cassette;
e) delivering the frame into a cassette and transferring the cassette with the frame having the secured donor sheet to a coating apparatus; and
f) repeating steps b) through e) for subsequent donor sheets to be coated.
